(19) United States
(12) Patent Application Publication
(10) Pub. No.: US 2026/0356540 A1
(43) Pub. Date: Nov. 12, 2026

(54) GLASS BOTTLE COVER ASSEMBLY

(71) Applicant: OLDWAN INC., Cheongju-si, Chungcheongbuk-do (KR)

(72) Inventor: Jae Hee SIM, Cheongju-si (KR)

(73) Assignee: OLDWAN INC., Cheongju-si, Chungcheongbuk-do (KR)

(21) Appl. No.: 19/122,640

(22) PCT Filed: Oct. 31, 2022
(86) PCT No.: PCT/KR2022/016838

§ 371 Date: Apr. 18, 2025

(30) Foreign Application Priority Data
Oct. 26, 2022 (KR) 10-2022-0138982

(51) Int. Cl. B65D 23/08; B65D 23/10; B65D 41/04

(52) U.S. Cl. CPC B65D 23/0885; B65D 23/106; B65D 41/04

(57) ABSTRACT

The present disclosure relates to a glass bottle cover assembly for protecting a glass bottle. The glass bottle cover assembly has a cover that surrounds the body of the glass bottle, a guide ring that is fastened to an upper recessed portion formed in an upper portion of the outer circumferential surface of the glass bottle, and a cap that opens and closes an opening portion formed at the upper end of the glass bottle. The guide ring includes a first fastening portion that is formed in the upper portion of the outer circumferential surface of the guide ring and coupled to the cap, and a second fastening portion that is formed in the lower portion of the guide ring and coupled to the cover.

### TECHNICAL FIELD

The present invention relates to a glass bottle cover assembly, and more particularly, to a cover assembly for protecting a glass bottle that contains chemicals used in a semiconductor process.

### RELATED ART

Glass bottles, which are widely used in daily life, are used in various ways depending on characteristics and purpose of the contents.

A photoresist (photosensitive solution) container used in a semiconductor photo process is made of a special material that contains ultraviolet (UV)-blocking paint using the principle of light refraction angle to protect the special property of a solution. The solution inside is also expensive and is generally stored in a thoroughly isolated manner since it is a substance harmful to the human body when leaked to the outside.

The size of the container is usually 1 gallon (3.8 liters) and its volume and shape are standardized.

Due to the nature of the solvent, its photosensitivity is sensitive to external temperature, and it is stored in a constant temperature facility with 23 degrees (general storage temperature is 4 degrees or lower). In reality, it is classified as a hazardous and dangerous substance due to concerns about harm to the human body caused by cracks that occur due to careless handling, and its handling is restricted to only the authorized personnel.

Also, currently, interest in environment and safety increases. Therefore, in the event that a toxic substance leaks due to the breakage of a glass bottle containing chemicals, it may first cause harm to the human body of workers and negatively affect the external image of a semiconductor company, so there is a realistic need to very actively respond to prepare countermeasures.

By changing the glass bottle to a plastic material, problems of the conventional glass bottle are to be improved. However, in the case of a container made of a plastic material, the purity of a chemical solution through dissolution is not completely maintained, so the use of the glass bottle is expected to continue for a considerable period of time.

Korean Patent Registration No. 10-2071399, a protection device patent, relates to a device that protects a photoresist bottle used in a semiconductor photo process and includes a protection method that wraps around the outside of the bottle. However, for use in an actual photo process, the protection device needs to be removed to expose the bottle to the outside.

Korean Patent Registration No. 10-1746779 is a patent that relates to a cover assembly for protecting a chemical bottle, and a cover assembly manufactured based on a glass bottle with a handle. With the cover assembly being attached, a container lid is torn through a virgin ring, a cap of the chemical container is opened, and chemicals inside are used. Here, a process of containing chemicals in the chemical container, covering the same with the cover assembly again, and transporting the same needs to be performed. Also, there is the risk of damage during the process of transporting the chemical container to cover the cover assembly. The added process aggregates the substantial risk, which may cause the effectiveness issue in using the cover assembly.

### DETAILED DESCRIPTION

### Technical Subject

An objective of the present invention is to provide a glass bottle cover assembly that prevents a glass bottle containing hazardous chemicals from being broken due to impact and prevents the hazardous chemicals from leaking although the glass bottle is broken.

### Solution

A glass bottle cover assembly according to an example embodiment of the present invention relates to a glass bottle cover assembly for protecting a glass bottle, and includes a cover configured to surround a body of the glass bottle; a guide ring configured to fasten to an upper recess portion formed in an upper portion of the outer circumferential surface of the glass bottle; and a cap configured to open and close an opening formed at the upper end of the glass bottle, and the guide ring includes a first fastening portion formed in an upper portion of the outer circumferential surface of the guide ring and configured to couple to the cap, and a second fastening portion formed in a lower portion of the guide ring and configured to couple to the cover, and the cap is screw-coupled to a glass bottle screw thread formed on the outer circumferential surface between the opening of the glass bottle and the upper recess portion, and at the same time, configured to couple to the first fastening portion of the guide ring.

### Effect

According to a glass bottle cover assembly according to the present invention, it is possible to prevent a glass bottle containing hazardous chemicals from being broken and to prevent the hazardous chemicals from leaking to the outside of a cover although the glass bottle is broken.

### BRIEF DESCRIPTION OF DRAWINGS

FIG. 1 illustrates a front view of a glass bottle cover assembly according to an example embodiment of the present invention.

FIG. 2 illustrates a cross-sectional view of a glass bottle cover assembly according to an example embodiment of the present invention.

FIG. 3 illustrates an exploded view of a glass bottle cover assembly according to an example embodiment of the present invention.

FIG. 4 illustrates a perspective view and a front view of a guide ring according to an example embodiment of the present invention.

FIG. 5 illustrates a perspective view and a front view of a guide ring according to an example embodiment of the present invention.

FIG. 6 illustrates a perspective view and a front view of a guide ring according to an example embodiment of the present invention.

FIG. 7 illustrates a perspective view, a front view, and a plan view of a cap according to an example embodiment of the present invention.

### BEST MODE

The specific structural or functional descriptions of example embodiments according to the concept of the present invention disclosed herein are merely intended for the purpose of describing the example embodiments according to the concept of the present invention and the example embodiments according to the concept of the present invention may be implemented in various forms and are not construed as limited to the example embodiments described herein.

Various modifications may be made to the example embodiments according to the concept of the present invention and thus, the example embodiments are illustrated in the drawings and described in detail through the present specification. However, it should be understood that the example embodiments according to the concept of the present invention are not construed as limited to specific implementations and should be understood to include all changes, equivalents, or replacements within the idea and the technical scope of the present invention.

Although terms of “first,” “second,” and the like are used to explain various components, the components are not limited to such terms. These terms are used only to distinguish one component from another component. For example, a first component may be referred to as a second component, or similarly, the second component may be referred to as the first component without departing from the scope according to the concept of the present invention.

When it is mentioned that one component is “connected” or “accessed” to another component, it may be understood that the one component is directly connected or accessed to another component or that still other component is interposed between the two components. In addition, when it is described that one component is “directly connected” or “directly accessed” to another component, it should be understood that still other component is absent therebetween. Likewise, expressions describing relationships between components, for example, “between” and “immediately between” and “immediately adjacent to” may also be construed as described in the foregoing.

The terminology used herein is for the purpose of describing particular example embodiments only and is not to be limiting of the present invention. As used herein, the singular forms “a,” “an,” and “the” are intended to include the plural forms as well, unless the context clearly indicates otherwise. It will be further understood that the terms “comprises/includes” or “has,” when used in this specification, specify the presence of stated features, integers, stages, operations, components, parts, or combinations thereof, but do not preclude the presence or addition of one or more other features, integers, stages, operations, components, parts, or combinations thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments of the present invention will be described in detail with reference to the accompanying drawings. However, the scope of the patent is not limited or restricted by the example embodiments. Like reference numerals presented in the respective drawings refer to like components.

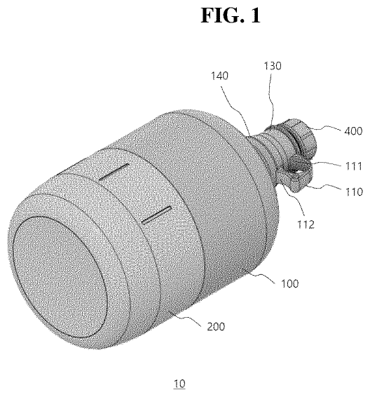

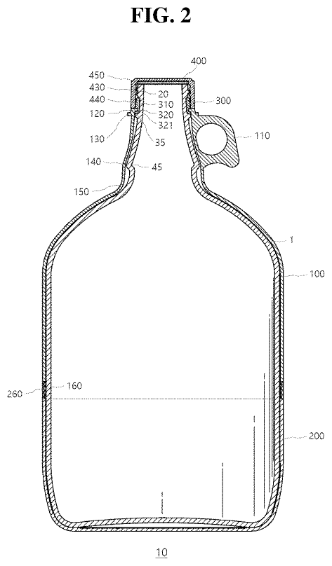

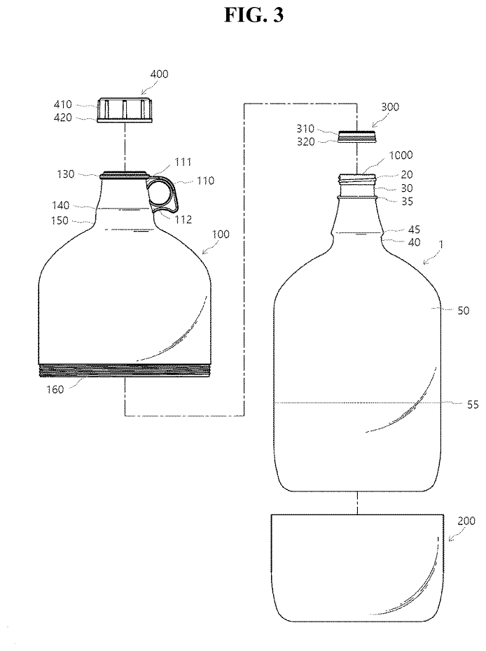

FIG. 1 illustrates a front view of a glass bottle cover assembly according to an example embodiment of the present invention, FIG. 2 illustrates a cross-sectional view of a glass bottle cover assembly (including glass bottle) according to an example embodiment of the present invention, and FIG. 3 illustrates an exploded view of a glass bottle cover assembly according to an example embodiment of the present invention.

As shown in FIGS. 1 to 3, a glass bottle cover assembly 10 according to an example embodiment of the present invention relates to the glass bottle cover assembly 10 for protecting a glass bottle 1 containing chemicals, and includes an upper cover 100 and a lower cover 200 configured to surround a body 50 of the glass bottle 1, a guide ring 300 configured to fasten to an upper recess portion formed in an upper portion of the outer circumferential surface of the glass bottle 1, and a cap 400 configured to open and close an opening 1000 formed at the upper end of the glass bottle 1 and to simultaneously couple to a glass bottle screw thread 20 formed on the upper outer circumferential surface of the glass bottle 1 and a fastening portion formed in an upper portion of the outer circumferential surface of the guide ring 300.

The glass bottle cover assembly 10 according to an example embodiment of the present invention may be the glass bottle cover assembly 10 for protecting the glass bottle 1 containing photoresist used in a semiconductor process, but is not necessarily limited thereto.

However, for convenience description, it is assumed that the glass bottle cover assembly 10 according to an example embodiment of the present invention is for photoresist used in the semiconductor process.

The photoresist used in the semiconductor process has a predetermined glass bottle specifications and shape, and a process of containing the photoresist in the glass bottle 1 is also standardized.

Roughly describing a process of containing the photoresist into the glass bottle 1, a process of manufacturing the glass bottle 1 and then washing the inside and outside of the glass bottle 1 is performed. After washing the glass bottle 1, the empty glass bottle 1 with a glass bottle cap not completely sealed is placed on a conveyor aligned for containing the photoresist, the cap 400 is opened with a device that holds the cap 400 of the glass bottle 1, and a hose is attached to the glass bottle 1 to fill the same with 1 gal of photoresist.

Then, as a storing process after completely closing and sealing the cap 400, a process just before the photoresist is used in the semiconductor process is completed.

The process itself needs to be performed in a clean state to store the photoresist in the glass bottle 1 without the risk of being contaminated or deteriorated by other components.

Also, the glass bottle 1 is exposed to the outside by itself and is simply wrapped in a plastic bag even during a transportation process, and there is no device to protect the glass bottle 1 from the risk of falling.

The glass bottle cover assembly 10 according to an example embodiment of the present invention is invented to prevent the risk of photoresist, chemical substance, leaking to the outside although the glass bottle 1 breaks during the process of containing the photoresist in the glass bottle 1, and storing, transporting, and using the same in the semiconductor process.

As shown in FIGS. 1 and 2, the glass bottle cover assembly 10 according to an example embodiment of the present invention wraps the glass bottle 1 with the cover, and desirably, the cover is divided into the upper cover 100 and the lower cover 200, which are combined to surround the body 50 of the glass bottle 1.

A material of the upper cover 100 and the lower cover 200 includes one of glycol-modified polyethylene terephthalate (PETG), low density polyethylene (LDPE), high density polyethylene (HDPE), polypropylene (PP), polyethylene terephthalate (PET), acrylic resin, polycarbonate (PC), acrylonitrile butadiene styrene (ABS), Teflon, and thermoplastic elastomer (TPE).

The upper cover 100 may include a handle 110 formed on one side of the outer circumferential surface, a guide ring fastening portion 120 formed to protrude inward from the inner circumferential surface in an upper portion of the inner circumferential surface, a protruding portion 130 located below the guide ring fastening portion 120 and formed to protrude outward from the outer circumferential surface and to be in contact with an annular lip 35 of the glass bottle 1, a protrusion coupling portion 140 located below the protruding portion 130 and formed to protrude outward from the outer circumferential surface and to be in contact with an annular protruding portion 45 of the glass bottle 1, a cover recess portion 150 formed below the protrusion coupling portion 140, and an upper cover assembly screw thread 160 formed in a lower portion of the outer circumferential surface and configured to couple to the lower cover 200.

Also, the upper cover 100 may further include a groove portion (not shown) formed between handle connection portions to prevent deformation of the handle 110.

As shown in FIG. 3, the top of the upper cover 100 is in an open state and the guide ring fastening portion 120 may be formed to protrude inward at a portion most adjacent to the open top. The guide ring fastening portion 120 of the upper cover 100 may couple to the lower outer circumferential surface of the guide ring 300 to more firmly seal the glass bottle 1.

The protruding portion 130 may be formed below the guide ring fastening portion 120, and the protruding portion 130 may be implemented in an arc shape that protrudes convexly compared to the overall upper portion shape of the upper cover 100. The protruding portion 130 may be a portion that is firmly attached to the annular lip 35 formed in the glass bottle 1 when the upper cover 100 is fitted into the glass bottle 1.

Also, the handle 110 may be provided on the outer circumferential surface of the upper cover 100. For example, a first connecting portion 111 at which an upper portion of the handle 110 and the outer circumferential surface of the upper cover 100 are connected may be formed below the protruding portion 130, and a second connecting portion 112 at which a lower portion of the handle 110 and the outer circumferential surface of the upper cover 100 are connected may be formed on the protrusion coupling portion 140. That is, the handle 110 may be formed between the protruding portion 130 and the protrusion coupling portion 140. A location or a shape of the handle 110 is not limited thereto and may be variously modified depending on a shape of a cover assembly.

As shown in FIGS. 1 to 3, below the protruding portion 130, the diameter increases in a form in which a cross-section widens and, while forming a recessed cross-section like the cover recess portion 150, the protrusion coupling portion 140 may be formed in a corresponding connecting portion.

The protrusion coupling portion 140 is a portion that is firmly attached to the annular protruding portion 45 formed in the glass bottle 1 when the upper cover 100 is fitted into the glass bottle 1.

Referring to the shape of the glass bottle 1 used in the semiconductor process through FIG. 3, the opening 1000 is formed in an upper portion and the glass bottle screw thread 20 configured to couple to the cap 400 is formed in the upper outer circumferential surface. An upper recess portion 30 having a smaller diameter than that of the opening 1000 is formed in a lower portion of the glass bottle screw thread 20. The protruding ring-shaped annular lip 35 is formed in a lower portion of the upper recess portion 30, and a lower recess portion 40 is formed in a form in which a diameter increases with going downward and then rapidly decreases.

The annular protruding portion 45 is formed at the upper end of the lower recess portion 40, and the body 50 of which diameter increases with going downward from the lower recess portion 40 to the glass bottle 1 and having the same diameter at a certain height is formed to hold 1 gal of photoresist.

The upper recess portion 30 and the lower recess portion 40 formed in the glass bottle 1 correspond to the space for holding the glass bottle 1 with hand or fixing a finger when carrying the glass bottle 1, and while maintaining the shape of the existing glass bottle, the glass bottle cover assembly 10 may firmly couple to the glass bottle 1 and may protect a worker from inside hazardous chemicals although the glass bottle 1 breaks.

Also, a gradient may be formed such that the diameter of the body 50 of the glass bottle 1 increases with going down from an upper portion of the body 50 to an annular bend 55 and decreases with going down from the annular bend 55 to a lower portion of the body 50. The annular bend 55 enables the glass bottle cover assembly 10 to more firmly couple to the glass bottle 1.

As shown in FIG. 2, the protrusion coupling portion 140 of the glass bottle cover assembly 10 described above is in close contact with the annular protruding portion 45 of the glass bottle 1, and functions to naturally fasten the glass bottle 1 to not move or shake inside the glass bottle cover assembly 10.

The cover recess portion 150 is formed below the protrusion coupling portion 140 and serves to support the protruding annular protruding portion 45 of the glass bottle 1. This structure makes it easy to fasten the upper cover 100 to the glass bottle 1, while preventing the fastened glass bottle 1 from easily separating from the upper cover 100.

Also, the upper cover assembly screw thread 160 configured to couple to the lower cover 200 is formed on the lower outer circumferential surface of the upper cover 100, and the upper cover assembly screw thread 160 couples the upper cover 100 and the lower cover 200 by engaging with a lower cover assembly screw thread 260 formed on the upper inner circumferential surface of the lower cover 200. However, without being limited thereto, a screw thread may be formed on the lower inner circumferential surface of the upper cover 100 and the upper outer circumferential surface of the lower cover 200, and the upper cover 100 and the lower cover 200 may be coupled accordingly.

Here, the upper cover 100 may be formed to cover from the upper recess portion 30 of the glass bottle 1 to the annular bend 55 of the glass bottle 1, and the lower cover 200 may be formed to cover from the upper cover assembly screw thread 160 of the upper cover 100 to the lower end of the glass bottle 1. It is not necessarily limited thereto. The lower cover 200 may be formed to cover from the annular bend 55 of the glass bottle 1 to the lower end of the glass bottle 1, and the upper cover 100 may be formed to cover from the upper recess portion 30 of the glass bottle 1 to the lower cover assembly screw thread 260 of the lower cover 200. That is, a coupling portion between the upper cover assembly screw thread 160 of the upper cover 100 and the lower cover assembly screw thread 260 of the lower cover 200 may be formed to be adjacent to the annular bend 55 of the glass bottle 1.

Further, the upper cover 100 and the lower cover 200 may be firmly attached through ultrasonic welding or another bonding member in a state in which they are screw-coupled. Here, preferably, the bonding member may have chemical resistance property.

The guide ring 300 according to an example embodiment of the present invention prevents foreign substances (cleaning solution during washing) from penetrating through space formed between the outer circumferential surface of the glass bottle 1 and the inner circumferential surface of the upper cover 100.

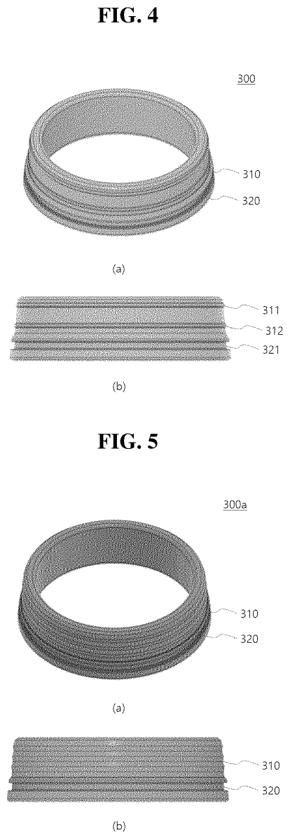

FIGS. 4 to 6 illustrate perspective views and front views of a guide ring according to an example embodiment of the present invention.

As shown in FIG. 3, the guide ring 300 to the upper recess portion 30 of the glass bottle 1. Preferably, the guide ring 300 is formed at the same height as that of the upper recess portion 30 and formed to be caught on the annular lip 35 of the glass bottle 1.

A material of the guide ring 300 may be ethylene propylene diene monomer (EPDM), but is not necessarily limited thereto. The guide ring 300 made of EPDM may easily fasten to the upper recess portion 30 of the glass bottle 1 due to its excellent adhesion and elastic restoring force.

Also, the guide ring 300 may include carbon. By mixing carbon that is a conductor, it is possible to prevent electrification and negative effect caused by static electricity, and it is possible to omit a separate antistatic agent for protecting the glass bottle 1 containing chemicals from static electricity.

As shown in FIG. 4, the guide ring 300 according to an example embodiment of the present invention may include a first fastening portion 310 formed in an upper portion of the outer circumferential surface of the guide ring 300 and configured to couple to a lower portion of the inner circumferential surface of the cap 400 and a second fastening portion 320 formed in a lower portion of the outer circumferential surface of the guide ring 300 and configured to couple to an upper portion of the inner circumferential surface of the upper cover 100, particularly, the guide ring fastening portion 120.

The guide ring 300 is fastened between the upper portion of the upper cover 100 and the glass bottle 1 and between a lower portion of the cap 400 and the glass bottle 1. In detail, the guide ring 300 may more firmly interconnect the upper cover 100 of the glass bottle 1 and the cap 400 in such a manner that the inner side of the guide ring 300 fastens to the upper recess portion 30 of the glass bottle 1, the lower inner circumferential surface of the cap 400 couples to the first fastening portion 310 of the guide ring 300, and the upper inner circumferential surface of the upper cover 100 couples to the second fastening portion 320 of the guide ring 300.

As shown in FIG. 2, the guide ring 300 is coupled between the upper cover 100 of the glass bottle 1 and the cap 400, thereby filling between the upper cover 100 of the glass bottle 1 and the cap 400. Through this, the risk of foreign substance penetration during washing may be eliminated.

Here, the first fastening portion 310 of the guide ring 300 may include a first protruding portion 311 and a second protruding portion 312 formed to protrude outward from the outer circumferential surface in a protruding arc shape compared to the overall shape of the first fastening portion 310. Here, the first protruding portion 311 may be formed in an upper portion of the first fastening portion 310, and the second protruding portion 312 may be formed in a lower portion of the first fastening portion 310 while being spaced part from the first protruding portion 311.

The second fastening portion 320 of the guide ring 300 according to an example embodiment of the present invention may include an arc-shaped fitting groove 321 formed recessed inward from the outer circumferential surface and configured to couple to the guide ring coupling portion 120 of the upper cover 100.

A shape of a fastening portion formed on the outer circumferential surface of the guide ring 300 is not limited thereto, and it may be formed in various shapes to firmly couple the upper cover 100 and the inner circumferential surface of the cap 400 depending on the diameter or the shape of the fastening portion on the inner circumferential surface of the upper cover 100 or the fastening portion on the inner circumferential surface of the cap 400.

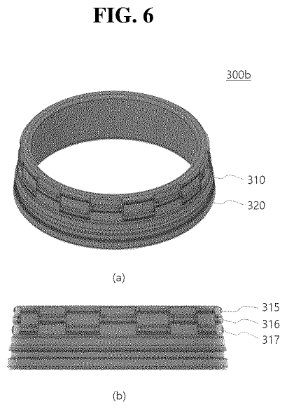

For example, as shown in FIG. 5, the first fastening portion 310 of a guide ring 300a may include a plurality of protruding portions formed in an arc shape in the circumferential direction of the guide ring 300a and formed spaced apart at regular intervals in a height direction. Also, as shown in FIG. 6, the first fastening portion 310 of a guide ring 300b may include a first line fastening portion 315 including a plurality of protruding portions formed spaced apart at regular intervals in the circumferential direction of the guide ring 300b, a second line fastening portion 316 including a plurality of protruding portions formed spaced apart at regular intervals in the circumferential direction of the guide ring 300, and a third line fastening portion 317 including a plurality of protruding portions formed spaced apart at regular intervals in the circumferential direction of the guide ring 300. Here, the protruding portion of the second line fastening portion 316 may be located at the bottom between the respective protruding portion of the first line fastening portion 315, and the protruding portion of the third line fastening portion 317 may be located at the bottom between the respective protruding portions of the second line fastening portion 316.

The second fastening portion 320 of the guide ring 300 according to another example embodiment of the present invention may be formed on the inner circumferential surface and fastened to cover the guide ring fastening portion 120 formed on the outer circumferential surface of the upper cover 100. That is, the cover assembly according to the example embodiment of the present invention may include all of various structures capable of ensuring airtightness and watertightness due to coupling of the guide ring 300 and the upper cover 100, and is not limited to only a single example embodiment.

In the following, for convenience of description, description is made based on an example embodiment in which the second fastening portion 320 is formed on the outer circumferential surface of the guide ring 300.

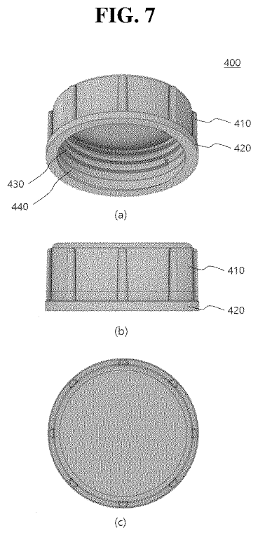

FIG. 7 illustrates a perspective view, a front view, and a plan view of a cap according to an example embodiment of the present invention.

The cap 400 according to an example embodiment of the present invention includes a cap body 410, a protruding cap 420 integrally coupled to the cap body 410 and formed to protrude outward from the outer circumferential surface in a lower portion of the outer circumferential surface of the cap 400, a first screw thread 430 formed in an upper portion of the inner circumferential surface of the cap 400, and a second screw thread 440 formed in a lower portion of the inner circumferential surface of the cap 400.

The first screw thread 430 formed in the upper portion of the inner circumferential surface of the cap 400 couples to the glass bottle screw thread 20 formed in the glass bottle 1, and the second screw thread 440 formed in the lower portion of the inner circumferential surface of the cap 400 couples to the first fastening portion 310 formed in the guide ring 300 to seal the glass bottle 1. The second screw thread 440 may not be screw-coupled to the first fastening portion 310 of the guide ring 300. Depending on the shape of the first fastening portion 310, various methods may be considered to ensure watertightness and airtightness by closely coupling the second screw thread 440 and the first fastening portion 310.

The cap 400 may further include a plurality of protruding portions to facilitate opening and closing of the cap 400 on the outer circumferential surface of the cap body 410. Also, the cap 400 may further include a cap insert 450 to improve the sealing between the inner surface of the upper end of the cap 400 and the upper end of the opening 1000 of the glass bottle 1. Here, a material of the cap insert 450 may be Teflon.

The additional scope of applicability of the present invention will become apparent from the detailed description set forth herein. However, since various modifications and alterations within the spirit and scope of the present invention may be clearly understood by one of ordinary skill in the art, the detailed description and specific example embodiments such as preferred example embodiments should be understood as being given as examples only.

The features and the effects of the present invention described above will become more apparent through the following detailed description with reference to the accompanying drawings, so one of ordinary skill in the art to which the present invention pertains may easily carry out the technical spirit of the present invention.

Various modifications may be made to the present invention and various example embodiments may be included and thus, specific example embodiments are illustrated in the drawings and described in detail through the present specification. However, it should be understood that the present invention is not construed as limited to specific implementations and should be understood to include all changes, equivalents, and replacements within the idea and the technical scope of the present invention.

What is claimed is:

1. A glass bottle cover assembly for protecting a glass bottle, comprising:
a cover configured to surround a body of the glass bottle;
a guide ring configured to fasten to an upper recess portion formed in an upper portion of the outer circumferential surface of the glass bottle; and
a cap configured to open and close an opening formed at the upper end of the glass bottle,
wherein the guide ring includes a first fastening portion formed in an upper portion of the outer circumferential surface of the guide ring and configured to couple to the cap, and a second fastening portion formed in a lower portion of the guide ring and configured to couple to the cover, and
the cap is screw-coupled to a glass bottle screw thread formed on the outer circumferential surface between the opening of the glass bottle and the upper recess portion, and at the same time, configured to couple to the first fastening portion of the guide ring.

2. The glass bottle cover assembly of claim 1, wherein the cover includes an upper cover and a lower cover.

3. The glass bottle cover assembly of claim 2, wherein the second fastening portion is formed on the outer circumferential surface of the guide ring and configured to couple to a guide ring fastening portion formed in the upper inner circumferential surface of the upper cover.

4. The glass bottle cover assembly of claim 3, wherein the upper cover includes:
a handle formed on one side of the outer circumferential surface;
a protruding portion located below the guide ring fastening portion and formed to protrude outward from the outer circumferential surface;
a protrusion coupling portion located below the protruding portion and formed to protrude outward from the outer circumferential surface;
a cover recess portion formed below the protrusion coupling portion; and
an upper cover assembly screw thread formed in a lower portion of the outer circumferential surface and configured to couple to the lower cover.

5. The glass bottle cover assembly of claim 4, wherein the upper cover further includes a groove portion located between a first connecting portion at which the outer circumferential surface of the upper cover and an upper portion of the handle are connected and a second connecting portion at which the outer circumferential surface of the upper cover and a lower portion of the handle are connected, and formed recessed inward from the outer circumferential surface.

6. The glass bottle cover assembly of claim 4, wherein the lower cover includes a lower cover assembly screw thread formed in an upper portion of the inner circumferential surface, and configured to couple to the upper cover assembly screw thread of the upper cover.

7. The glass bottle cover assembly of claim 6, wherein the upper cover is formed to cover from the second fastening portion of the guide ring to an annular bend of the glass bottle, and the lower cover is formed to cover from the upper cover assembly screw thread to a lower portion of the glass bottle.

8. The glass bottle cover assembly of claim 3, wherein the first fastening portion of the guide ring includes at least one protruding portion formed to protrude outward from the outer circumferential surface,
the second fastening portion of the guide ring includes a fitting groove formed recessed inward from the outer circumferential surface, and
the guide ring fastening portion of the upper cover is formed to protrude inward from the inner circumferential surface and configured to fasten to the fitting groove.

9. The glass bottle cover assembly of claim 1, wherein a material of the cover includes one selected from the group consisting of glycol-modified polyethylene terephthalate (PETG), low density polyethylene (LDPE), high density polyethylene (HDPE), polypropylene (PP), polyethylene terephthalate (PET), acrylic resin, polycarbonate (PC), acrylonitrile butadiene styrene (ABS), Teflon, and thermoplastic elastomer (TPE).

10. The glass bottle cover assembly of claim 1, wherein a material of the guide ring is ethylene propylene diene monomer (EPDM) or silicone.

11. The glass bottle cover assembly of claim 1, wherein a material of the guide ring includes carbon.

12. The glass bottle cover assembly of claim 1, wherein the cap includes:
a cap body;
a protruding cap integrally formed with the cap body and formed to protrude outward from the outer circumferential surface in a lower portion of the outer circumferential surface;
a first screw thread formed in an upper portion of the inner circumferential surface and configured to couple to the glass bottle screw thread; and
a second screw thread formed in a lower portion of the inner circumferential surface and configured to couple to the first fastening portion of the guide ring.
